(19) United States
(12) Patent Application Publication
(10) Pub. No.: US 2016/0290511 A1
(43) Pub. Date: Oct. 6, 2016

(54) SHAFT SEAL AND METHOD FOR PRODUCING SAME

(71) Applicant: SIEMENS AKTIENGESELLSCHAFT, München (DE)

(72) Inventor: Oliver Schneider, Wesel (DE)

(73) Assignee: Siemens Aktiengesellschaft, Munich (DE)

(21) Appl. No.: 15/035,429

(22) PCT Filed: Nov. 11, 2014
(86) PCT No.: PCT/EP2014/074229

§ 371 Date: May 9, 2016

(30) Foreign Application Priority Data
Nov. 19, 2013 (EP) 13193501.7

(51) Int. Cl. F16J 15/3292; F04D 29/10; F01D 11/00; F04D 29/053

(52) U.S. Cl. CPC F16J 15/3292; F04D 29/053; F04D 29/102; F01D 11/003; F05D 2220/32; F05D 2230/60; F05D 2240/60

(57) ABSTRACT

A shaft seal for reducing the leakage between two fluid spaces separated by the shaft seal, in particular two gas spaces arranged axially with respect to a shaft, wherein the shaft seal includes a plurality of flexible plate elements which are secured in a receptacle, wherein the receptacle constitutes a first diameter of the shaft seal, and wherein those ends of the plate elements which face away from the receptacle define a second diameter, wherein the plate elements have recesses at the ends facing away from the receptacle, wherein the plate elements have a first edge region and a second edge region, wherein the second edge region is wider than the first edge region.

### CROSS REFERENCE TO RELATED APPLICATIONS

This application is the US National Stage of International Application No. PCT/EP2014/074229 filed Nov. 11, 2014, and claims the benefit thereof. The International Application claims the benefit of European Application No. EP13193501 filed Nov. 19, 2013. All of the applications are incorporated by reference herein in their entirety.

### FIELD OF INVENTION

The present invention relates to a shaft seal for reducing the leakage between two fluid spaces separated by the shaft seal, and to a method for producing a shaft seal.

### BACKGROUND OF INVENTION

In gas turbines, turbochargers or compressors, gases are compressed or expanded along their throughflow direction axially with respect to a rotating shaft in a generally multi-stage process. In order to increase the efficiency of a compressor or of a turbine, a gas space upstream of a corresponding compressor stage or expansion stage is sealed with respect to a gas space downstream of this compressor stage or expansion stage in order to reduce leakage. To that end, use is made, inter alia, of labyrinth seals, brush seals or so-called leaf seals.

Labyrinth seals are classic sealing elements in turbomachinery. They are well known and are relatively simple and cost-effective for the producers to produce. Drawbacks of labyrinth seals lie in the relatively low tolerance for large rotor movements which frequently result in considerable wear. In order to improve this, the constructor is forced to provide correspondingly large gaps, which has a negative effect on the sealing effect and on performance.

Brush seals and leaf seals are sealing concepts which are deflected by the rotor during operation. Brush seals have blocks of wires which are elastic in all directions and are therefore not well-suited to sealing against a relatively high pressure difference, since the brushes move aside. In order to support the brushes, use is made, in part, of support rings. If the rotor comes closer to the brush, this bends backward, with a relatively wide gap resulting at higher pressure differences. Here, leaf seals offer notable advantages since the individual plate elements of the leaf seals are markedly stiffer than the brushes of the brush seal. However, in comparison to brush seals, leaf seals have the drawback that the plate elements generate a relatively high friction torque when starting up a rotating shaft. By forming a narrow but axially longer sealing gap along the boundary between two adjacent plate elements, the constructor, when using a leaf seal, must rely on this sealing gap remaining for the duration of operation of the leaf seal. An arrangement of multiple successive brush seals or leaf seals is uncommon for reasons of installation space and costs. EP 1 302 708 discloses a leaf seal for sealing a shaft in a turbomachine. EP 1 890 059 discloses a leaf seal which additionally broadens the principle of the leaf seal with a labyrinth seal between plate element and casing.

US 2012/0007318 A1 discloses a seal with a plurality of flexible seal strips.

### SUMMARY OF INVENTION

An object of the invention is to provide a shaft seal which, under the same framework conditions, is subjected to less mechanical and/or thermal load than the known sealing concepts.

This object is achieved with the features of the independent claims. Preferred embodiments thereof are indicated in the further patent claims.

The inventive shaft seal for reducing the leakage between two fluid spaces separated by the shaft seal, in particular two gas spaces arranged axially with respect to a shaft, comprises multiple flexible plate elements which are secured in a recess, wherein the recess represents a first diameter of the shaft seal, and wherein those ends of the plate elements oriented away from the recess define a second diameter, characterized in that the plate elements have recesses at the ends oriented away from the recess.

The inventive shaft seal has the advantage that the recesses at the end of the plate elements oriented away from the recess reduce the start-up or friction torque between the plate elements and the shaft or a casing. As a consequence of the lower friction torque, the introduction of heat into the plate elements is also reduced, such that the plate elements can possibly be guided with smaller gaps in the recess.

Advantageous refinements of and improvements to the shaft seal indicated in the independent claim are made possible by the measures set out in the dependent claims.

One advantageous refinement consists in additional recesses being provided in the plate elements. The additional recesses permit a further reduction in the stiffness of the plate elements radially with respect to the shaft, i.e. in the direction of rotation of the shaft, and thus a further reduction in the start-up torque. Furthermore, by virtue of the recesses, the stiffness axially with respect to the shaft, i.e. in the sealing direction of the plate elements, is essentially retained. It is particularly advantageous in that context if the recesses are arranged in a honeycomb shape or in a check shape. Such a configuration makes it possible for small swirl chambers to be introduced into the plate elements, wherein the resulting swirl chambers reduce the friction surface and reduce an introduction of heat in the event of mechanical contact between the plate element and the shaft. The formation of the swirl chambers is also advantageous because, in contrast to a labyrinth seal, it allows particularly good dissipation of the swirl component of the flow.

Furthermore, it is advantageously provided that the first diameter is an outer diameter of the shaft seal and the second diameter is an inner diameter of the shaft seal. In this configuration, the recess forms the outer diameter of the shaft seal, wherein the recess can be simply and cost-effectively secured in a casing.

Another refinement of the inventive shaft seal consists in that the plate elements have a first rim region and a second rim region, wherein the second rim region is wider than the first rim region. An asymmetric configuration of the plate element offers multiple advantages. On one hand, in the case of a co-directional, parallel arrangement, the second, wider rim region can have a particularly good sealing effect. On the other hand, such an asymmetric configuration of the plate elements, in particular if the width of the second rim region is wider, by approximately the width of one recess, than the first rim region, can achieve the possibility of creating, with just one variant of plate elements, a seal in which the respective recesses in one plate element are completely covered by webs, which are arranged between the recesses, in the successive plate element which is arranged rotated through 180°. To that end, the webs are made wider than the recesses in order to permit complete covering of the recess by a web.

It is further advantageously provided that the shaft seal has at least one plate element having no recesses, i.e. at least one plate element without recesses is arranged between the plate elements with recesses. Such a plate element without recesses allows the sealing effect to be increased, the friction and thus the start-up moment being increased only insignificantly by a plate element without recesses or individual plate elements without recesses, advantageously distributed over the circumference.

Another advantageous refinement consists in that raised portions on a shaft engage in the recesses of the plate elements when the shaft seal is mounted on the shaft. In the case of a co-directional arrangement of the plate elements, it is possible, here, depending on the height of the raised portions, to achieve an additional labyrinth seal in the recesses of the plate elements; alternatively, there may be present, on the shaft, small raised portions which generate eddies on the sealing edge between the plate element and the shaft, the sealing effect being increased by the eddies in the region of the sealing edge.

The invention also relates to a method for producing a shaft seal, it being in particular provided that just one variant of asymmetric plate elements is provided, which plate elements can for example be produced cost-effectively as injection-molded parts and stamped parts. In that context, every second plate element is respectively arranged rotated through 180° with respect to the adjacent plate element, such that the recesses of one plate element are respectively completely closed by the webs of the adjacent plate element.

Exemplary embodiments of a shaft seal according to the invention are explained below with reference to the appended drawings. In that context, identical components or components having identical functions are labeled with identical reference signs.

### BRIEF DESCRIPTION OF THE DRAWINGS

FIG. 1 shows a shaft with an inventive shaft seal.

FIG. 2 shows a radial section through the shaft with an inventive shaft seal.

FIG. 3 shows a plate element of an inventive shaft seal.

FIG. 3a shows an alternative plate element of an inventive shaft seal.

FIG. 3b shows another exemplary embodiment of a plate element of an inventive shaft seal.

FIG. 4 shows an arrangement of multiple plate elements of an inventive shaft seal.

### DETAILED DESCRIPTION OF INVENTION

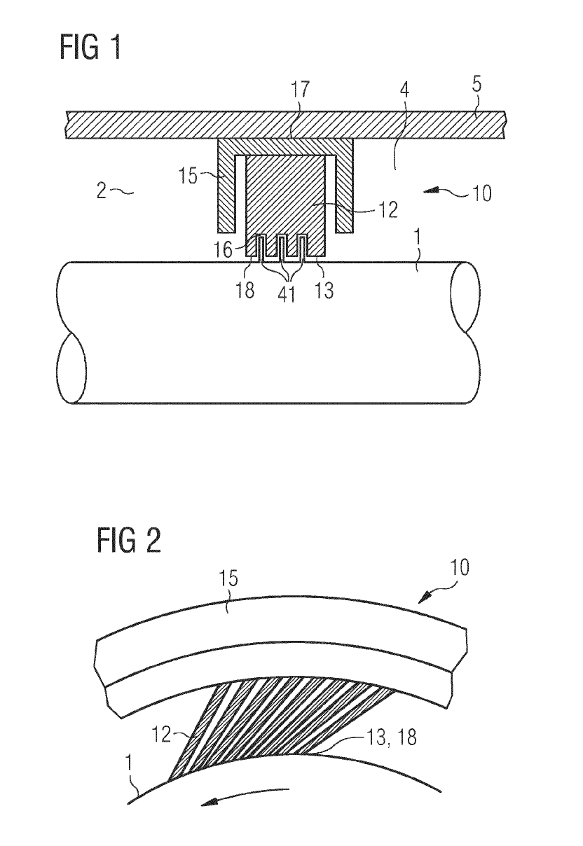

FIG. 1 shows an exemplary embodiment of an inventive shaft seal 10. The shaft seal 10 has a recess 15 in which multiple flexible plate elements 12 are secured. The shaft seal 10 is inserted into a casing 5, the recess 15 being secured to the casing 5, for example by being pressed into a form fit. That side of the recess 15 oriented toward the casing 5 then defines a first diameter 17. The plate elements 12 have ends 13 oriented away from the recess 15 and toward a shaft 1, wherein, when the shaft 1 is stationary, the ends 13 of the plate elements 12 bear against the shaft 1. The shaft seal 10 seals, in the axial direction along the shaft 1, a first fluid space 2 with respect to a second fluid space 4. The ends 13 of the plate elements 12 then define a second diameter 18.

The plate elements 12 have, at their ends 13 oriented toward the shaft 1, recesses 16 which are separated from one another by webs 19. Raised portions 41, which are arranged opposite the recesses 16 of the plate elements 12 and can engage in the recesses 16, can be formed on the shaft 1. Raised portions 41 engaging in the recesses 16 create a labyrinth which increases the sealing effect in the axial direction along the plate elements 12.

The shaft 1 rotates during operation, wherein, in the start-up phase, the plate elements 12 of the shaft seal 10 still bear initially against the shaft 1 and, because of the dynamics, lift off from the shaft 1 above a certain shaft speed, forming a sealing gap 11. FIG. 2 shows a rotating shaft 1 in radial section, the direction of rotation of the shaft 1 being indicated by an arrow. The recesses 16 reduce both a contact surface between the plate element 12 and the shaft 1, and the stiffness of the plate elements 12, thus reducing the friction and hence the introduction of heat into the plate elements 12 during the start-up process.

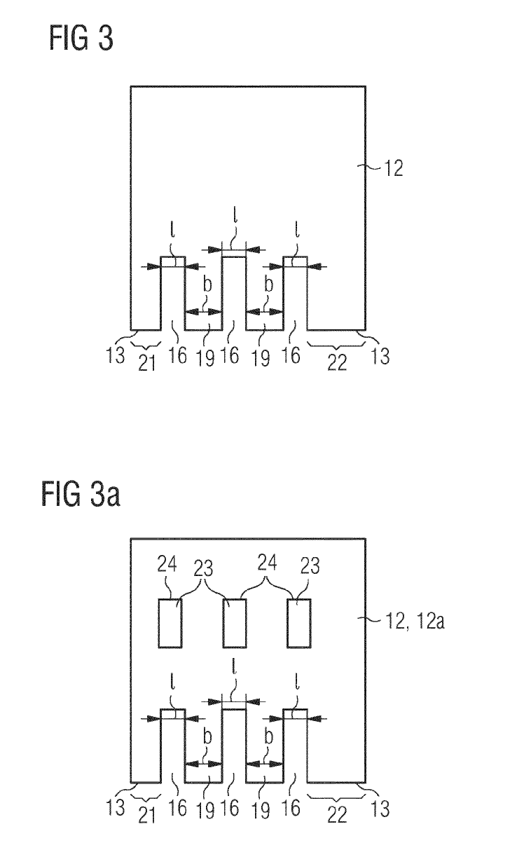

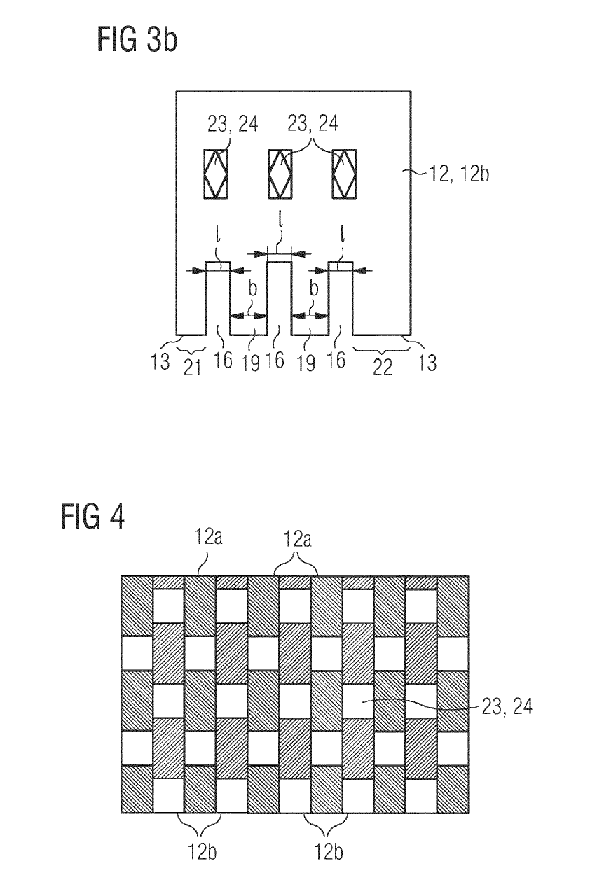

FIG. 3 discloses an exemplary embodiment of a plate element 12 of an inventive shaft seal 10. The plate element 12 has, at its end 13, recesses 16 which are separated by webs 19. Thus, the shape of the plate element 12 is asymmetric, the plate element 12 being bounded in the region of the recesses 16 by a first rim region 21 and a second rim region 22. The recesses 16 have a width l which is smaller than a width b of the webs 19. In that context, the first rim region 21 is narrower, by approximately the width l, than the second rim region 22.

FIG. 3a shows an alternative exemplary embodiment of a plate element 12 which, while having essentially the same structure as the embodiment shown in FIG. 3, also has additional recesses 23 which are for example check-shaped or lozenge-shaped. The additional recesses 23 further reduce the thermal conductivity of the plate elements 12 and the stiffness in the radial direction with respect to the shaft 1, while the stiffness in the axial direction is essentially retained. The additional recesses 23 create swirl chambers 24. If the surface of the plate elements 12 is smooth, the flow is less turbulent, such that after the inlet eddy a clean gap flow develops, which facilitates flow through the gap.

However, in the case of a sealing element, this is not desired. For that reason, the swirl chambers 24 generate additional turbulence, which increases the sealing effect between two adjacent plate elements 12. In the event of mechanical contact between the plate element 12 and the shaft 1, the input of heat is greatly reduced because the recesses 16 and swirl chambers 24 reduce the friction surface and reduce thermal conduction along the plate element 12.

FIG. 3b shows another exemplary embodiment of a plate element 12. In that context, the plate element 12a is shown rotated through 180°, with respect to the representation in FIG. 3a, as plate element 12b. If the plate elements 12 are ordered in each case rotated by 180° with respect to one another, such that each plate element 12a is adjacent to a plate element 12b, then the webs 19 of the plate element 12a in each case cover the recesses 16 of the plate element 12b, and the webs 19 of the plate element 12b cover the recesses 16 of the plate element 12a, the additional recesses 23 respectively creating swirl chambers 24 between the plate elements 12a, 12b. Such an arrangement of multiple plate elements 12a, 12b over the circumference of the shaft seal 10 is shown in FIG. 4.

Alternatively, it is also possible for at least one plate element 12 to be replaced with a plate element without recesses in order to increase the sealing effect. Alternatively, it is also possible for individual plate elements 12 without recesses to be arranged over the circumference of the shaft seal 10, advantageously evenly distributed over the circumference.

Furthermore, a shaft 1 can also have raised portions 41 which, in dynamic operation of the shaft 1, do not engage in the recesses 16 of the plate elements 12, or do so only to a negligible extent. Instead of a labyrinth seal, this creates small eddies along the shaft 1, which can also increase the sealing effect in comparison to a flat shaft 1.

Although the invention has been described in more detail by way of the preferred exemplary embodiments, the invention is not restricted to the disclosed exemplary embodiments and other variations can be derived herefrom by a person skilled in the art without departing from the scope of protection of the invention.

1. A shaft seal for reducing the leakage between two fluid spaces separated by the shaft seal, the shaft seal comprising:
multiple flexible plate elements which are secured in a recess,
wherein the recess represents a first diameter of the shaft seal, and wherein those ends of the plate elements oriented away from the recess define a second diameter,
wherein the plate elements have recesses at the ends oriented away from the recess,
wherein the plate elements have a first rim region and a second rim region, wherein the second rim region is wider than the first rim region.

2. The shaft seal as claimed in claim 1,
wherein the plate elements have additional recesses.

3. The shaft seal as claimed in claim 2,
wherein the additional recesses form swirl chambers.

4. The shaft seal as claimed in claim 1,
wherein the first diameter is an outer diameter of the shaft seal and the second diameter is an inner diameter of the shaft seal.

5. The shaft seal as claimed in claim 1,
wherein the second rim region is wider, by approximately the width of one recess, than the first rim region.

6. The shaft seal as claimed in claim 1,
wherein webs are provided between the recesses.

7. The shaft seal as claimed in claim 6,
wherein the webs are wider than the recesses.

8. The shaft seal as claimed in claim 7,
wherein the plate elements are arranged alternately rotated through 180°, so as to completely close the recesses or the additional recesses of a plate element with the webs of the next plate element.

9. The shaft seal as claimed in claim 1,
wherein at least one plate element, which has no recesses, is arranged between the plate elements.

10. The shaft seal as claimed in claim 1, further comprising
raised portions on a shaft which engage in the recesses of the plate elements when the shaft seal is mounted on the shaft.

11. A gas turbine having
a shaft seal as claimed in claim 1.

12. A method for producing a shaft seal for reducing the leakage between two fluid spaces separated by the shaft seal, the method comprising:
securing multiple flexible plate elements in a recess, wherein the recess defines a first diameter of the shaft seal, and
orienting those ends of the plate elements away from the recess to define a second diameter,
introducing recesses into the plate elements at the end oriented away from the recess,
respectively arranging every second plate element rotated through 180°, such that the recesses of one plate element are completely closed by webs of the subsequent plate element.

13. The method of claim 12,
wherein the shaft seal is arranged so as to separate two gas spaces arranged axially with respect to a shaft.

14. The shaft seal of claim 1,
wherein the two fluid spaces comprise two gas spaces arranged axially with respect to a shaft.

15. The shaft seal of claim 2,
wherein the additional recesses comprise honeycomb-shaped or check-shaped recesses.
